(19) United States
(12) Patent Application Publication
(10) Pub. No.: US 2021/0102096 A1
(43) Pub. Date: Apr. 8, 2021

(54) SILICONE RELEASE FILM, AND PROTECTIVE FILM COMPRISING SAME FOR ADHESIVE FILM AND ADHESIVE TAPE

(71) Applicant: TORAY ADVANCED MATERIALS KOREA INC., Gumi-si (KR)

(72) Inventors: Byung Cheol Ahn, Gumi-si (KR); Jung Hwan Lee, Gumi-si (KR); Tae Gyu Choi, Gumi-si (KR); Kil Joong Kim, Gumi-si (KR); Gi Jeong Moon, Gumi-si (KR)

(21) Appl. No.: 17/126,029

(22) Filed: Dec. 18, 2020

Related U.S. Application Data
(63) Continuation of application No. PCT/KR2019/007300, filed on Jun. 18, 2019.

(30) Foreign Application Priority Data
Jun. 20, 2018 (KR) 10-2018-0070902

(51) Int. Cl. C09J 7/40; C08G 77/08; C08G 77/12; C08G 77/20; C08K 5/5419; C08K 5/5425; C08K 5/5435; C08K 5/5465

(52) U.S. Cl. CPC C09J 7/401; C09J 7/405; C08G 77/08; C08G 77/12; C08G 77/20; C08G 2170/80; C08K 5/5425; C08K 5/5435; C08K 5/5465; C09J 2301/30; C09J 2483/005; C08K 5/5419

(57) ABSTRACT

Provided are a silicone release film and a protective film for adhesive films and adhesive tapes including the same. The silicone release film may provide excellent delamination characteristics in various peel-off speed ranges regardless of external environmental changes, such as passage of time or temperature changes.

### CROSS-REFERENCE TO RELATED APPLICATIONS

This application is a continuation of, and claims priority to, International Application No. PCT/KR2019/007300 filed on Jun. 18, 2019 and entitled SILICONE RELEASE FILM, AND PROTECTIVE FILM COMPRISING SAME FOR ADHESIVE FILM AND ADHESIVE TAPE, which claims priority to Korean Patent Application No. 10-2018-0070902 filed Jun. 20, 2018, the disclosures of which are hereby incorporated by reference in their entirety.

### TECHNICAL FIELD

The present disclosure relates to a silicone release film and a protective film including the same for adhesive films and adhesive tapes.

### BACKGROUND ART

A release film refers to a film having releasability that does not easily stick to adhesive components and may be used as a protective film on an adhesive film or an adhesive tape the like. For example, the release film is used to prevent undesired adhesion of an adhesive to an adherend before use or to inhibit contamination of the adhesive by foreign matters. The release film is removed before use.

As such release films, silicone release films including a silicone release layer formed by coating a silicone release composition including polysiloxane as a main component have commonly been used.

Recently, as manufactured products have reduced in size and weight in accordance with the development of technologies, demands on adhesive films including thin silicone release films have gradually increased and methods of forming the adhesive films with a reduced thickness of a base material or without the base material are employed as a trend. Also, speed of peeling off the silicone release film from the adhesive film tends to increase more to improve productivity.

Thus, delamination characteristics may deteriorate at a high peel-off speed, causing a problem of tearing of an adhesive layer. Or, in a double-sided adhesive film pressed between a light peel-off release film having a low peel-off strength and a heavy peel-off release film having a high peel-off strength, when the light peel-off release film is first peeled off from the adhesive film, a problem of delamination of an adhesive layer together therewith may occur since the light peel-off release film is heavily peeled off.

To solve these problems, there is still a need to develop a novel silicone release film having improved delamination characteristics and a protective film for adhesive films and adhesive tapes including the silicone release film.

### DESCRIPTION OF EMBODIMENTS

### Technical Problem

Provided is a silicone release film having improved delamination characteristics.

Provided is a protective film including the silicone release film for adhesive films.

Provided is a protective film including the silicone release film for adhesive tapes.

### Solution to Problem

According to an aspect of the present disclosure, a silicone release film includes:

a base film; and

a release layer located on at least one side of the base film and including a silicone release composition,

wherein the release layer satisfies all of Equations 1 to 3 below:

10≤L≤25 Equation 1

10≤H≤40 Equation 2

1≤H/L≤2 Equation 3

In Equations 1 to 3,

L (gram/inch) is a low-speed peel-off strength value measured at a peel-off speed of 0.3 m/min,

H (gram/inch) is a high-speed peel-off strength value measured at a peel-off speed of 30 m/min, and

the low-speed peel-off strength value and the high-speed peel-off strength value are values measured after a TESA7475 tape was pressed in a reciprocating manner and maintained at room temperature for 1 day, respectively.

According to another aspect of the present disclosure,

a protective film for an adhesive film includes the above-described silicone release film.

According to another aspect of the present disclosure,

a protective film for an adhesive tape includes the above-described silicone release film.

### ADVANTAGEOUS EFFECTS OF DISCLOSURE

The silicone release film according to an embodiment may have excellent delamination characteristics in various peel-off speed ranges. By inhibiting deterioration in delamination characteristics caused by changes in external environment such as passage of time or temperature change, problems occurring while processing the silicone release film may be prevented.

### BRIEF DESCRIPTION OF DRAWINGS

FIG. 1 is a cross-sectional view of a silicone release film according to an embodiment.

### MODE OF DISCLOSURE

Hereinafter, a silicone release film and a protective film for adhesive films and adhesive tapes including the same will be described with reference to embodiments and drawings of the present disclosure. These embodiments are only provided by way of example to illustrate the present invention in more detail, and it will be apparent to those skilled in the art that the scope of the present invention is not limited by these embodiments.

Unless otherwise defined, technical and scientific terms used herein have the same meaning as commonly understood by one or ordinary skill in the art to which this application belongs. However, in the event of any conflict or inconsistency between terms used herein and terms of the cited references, the terms used in this specification take precedence over the terms of the cited references.

Although methods and materials similar or equivalent to those described in the specification may be used in embodiments or experiments of the present invention, appropriate methods and materials are described in the specification.

In the drawings, thicknesses of various layers and regions may be enlarged for clarity. Throughout the specification, like reference numerals denote like elements.

Throughout the specification, when an element is referred to as being “on” another element, it can be directly on the other element or intervening elements may be present therebetween. In contrast, when an element is referred to as being “directly on” another element, there are no intervening elements present.

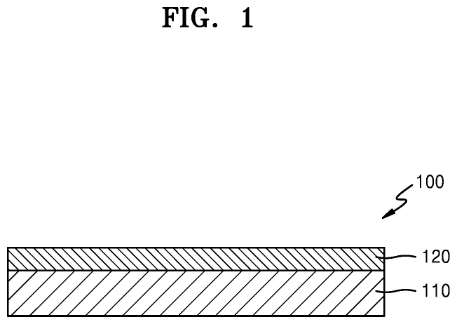

Throughout the specification, the term “include” is intended to indicate that an element do not preclude the other elements but further add and/or intervene another element, unless otherwise stated. Hereinafter, a silicone release film according to an embodiment of the present disclosure will be described with reference to FIG. 1.

Recently, a method of coating an adhesive composition on a silicone release film has been applied to construct an adhesive film. In a process of forming an adhesive layer by drying and curing the coated adhesive composition, a problem of deterioration in delamination characteristics of the silicone release film may arise due to passage of time or temperature change. Also, as a peel-off speed of the silicone release film increases to improve productivity, delamination characteristics may deteriorate, causing a problem of tearing of the adhesive layer or delamination of the adhesive layer in undesirable circumstances may occur.

The present inventors have suggested a silicone release film having improved delamination characteristics as follows to solve the problems.

FIG. 1 is a cross-sectional view of a silicone release film according to an embodiment.

Referring to FIG. 1, a silicone release film 100 includes a base film 110 and a release layer 120 located on at least one side of the base film 110 and including a silicone release composition. The release layer 120 including the silicone release composition may be formed on one side of the base film 110 and both sides of the base film 110.

The silicone release film 100 according to an embodiment includes the base film 110 and the release layer 120 located on at least one side of the base film 110 and including the silicone release composition, wherein the release layer 120 may satisfy all of Equations 1 to 3 below:

10≤L≤25 Equation 1

10≤H≤40 Equation 2

1≤H/L≤2 Equation 3

In Equations 1 to 3,

L (gram/inch) is a low-speed peel-off strength value measured at a peel-off speed of 0.3 m/min,

H (gram/inch) is a high-speed peel-off strength value measured at a peel-off speed of 30 m/min, and

the low-speed peel-off strength value and the high-speed peel-off strength value are values measured after a TESA7475 tape was pressed in a reciprocating manner and maintained at room temperature for 1 day, respectively.

Because the silicone release composition included in the release layer is designed to satisfy the low-speed peel-off strength measured at a peel-off speed of 0.3 m/m in for silicone release films commonly used in the art, polysiloxane having a high molecular weight may be applied to obtain the low-speed peel-off strength as shown in Equation 1. In this case, the release layer of the silicone release film may be formed to have a smaller number of crosslink points generated by reaction between an alkenyl group-containing organic polysiloxane and a hydrogen-containing organic polysiloxane compared to the molecular weight. For example, molecules are designed and synthesized such that one crosslink point is generated for every molecular weight of 4,000 to 100,000 of crosslinked silicone, and then applied to the silicone release composition. Accordingly, although the low-speed peel-off strength measured at a peel-off speed of 0.3 m/min may be maintained at a low level, the high-speed peel-off strength measured at a peel-off speed of 30 m/min may considerably increases due to high dependence of the peel-off strength on the peel-off speed. In this case, as the peel-off speed of the adhesive is increased to improve productivity, delamination characteristics deteriorate, and thus problems of tearing of the adhesive layer including the silicone release film or delamination of the adhesive layer together therewith may occur.

Because the silicone release film 100 according to an embodiment satisfies all of Equations 1 to 3, problems of tearing of the adhesive layer including the silicone release film or delamination of the adhesive layer in advance before use may not occur.

The release layer 120 satisfies both Equations 4 and 5 below:

1.0≤R14/R1≤1.5 Equation 4

1.0≤P89/P25≤1.5 Equation 5

In Equations 4 and 5,

R1 (gram/inch) is a low-speed peel-off strength value measured at a peel-off speed of 0.3 m/min after a TESA7475 tape was pressed in a reciprocating manner and maintained at room temperature for 1 day,

R14 (gram/inch) is a low-speed peel-off strength value measured at a peel-off speed of 0.3 m/min after a TESA7475 tape was pressed in a reciprocating manner and maintained at room temperature for 14 days,

P25 (gram/inch) is a low-speed peel-off strength value measured at a peel-off speed of 0.3 m/min after a TESA7475 tape was pressed in a reciprocating manner and maintained at room temperature for 1 day, and

P80 (gram/inch) is a low-speed peel-off strength value measured at a peel-off speed of 0.3 m/min after a TESA7475 tape was pressed in a reciprocating manner and maintained at 80° C. for 1 day.

The silicone release film including the release layer 120 satisfies Equations 4 and 5, peel-off strength changes due to temperature changes and passage of time may be inhibited. Therefore, a silicone release film having improved delamination characteristics in which the peel-off strength is constantly maintained even after passage of time or temperature changes may be provided.

The silicone release composition may include an alkenyl group-containing organic polysiloxane having a substituted or unsubstituted C2-C12 alkenyl group, a hydrogen-containing organic polysiloxane, or any combination thereof.

The silicone release composition may include a structural unit represented by Formulae 1 to 3 below:

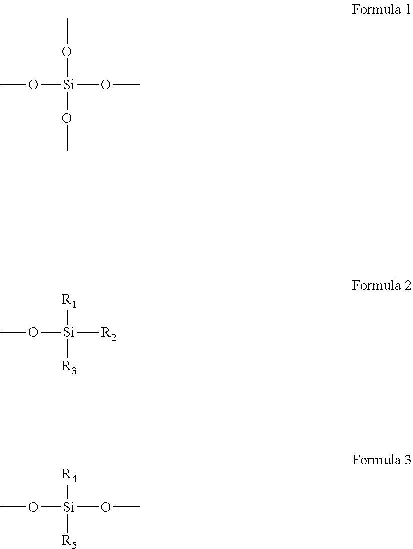

In Formulae 1 to 3,

R₁, R₂, R₃, R₄, and R₅ may be each independently a substituted or unsubstituted C1-C12 alkyl group or a substituted or unsubstituted C2-C12 alkenyl group.

The silicone release composition may include at least one structural unit represented by Formula 1 and at least four structural units represented by Formula 2. Also, the silicone release composition may include at least one structural unit represented by Formula 3.

Accordingly, the alkenyl group-containing organic polysiloxane additionally has one crosslink point in the molecule, and the silicone release film including the same may be synthesized by designing molecules such that one or more crosslink points are generated for every molecular weight less than 4000 of the crosslinked silicone constituting the release layer.

The alkenyl group-containing organic polysiloxane may include an organic polysiloxane represented by Formula 4 below:

{R′₁R′₂R′₃SiO_{1/2}}ₙ{R′₂R′₃SiO_{2/2}}ₘ{R′₃SiO_{3/2}}ₗ{SiO_{4/2}}ₖ Formula 4

In Formula 4,

n may be an integer from 4 to 10,

m may be an integer from 10 to 200,

l may be 0,

k may be an integer from 1 to 4,

R′₁ and R′₂ may be each independently a substituted or unsubstituted C1-C12 alkyl group or a substituted or unsubstituted C2-C12 alkenyl group,

R′₃ may be a substituted or unsubstituted methyl group, and

at least one of R′₁ and R′₂ may be a substituted or unsubstituted C2-C12 alkenyl group.

The n, m, l, and k do not mean block bonding, but they mean sums of repeating units, respectively. In the equation above, the repeating units corresponding to the n, m, l, and k may be bonded via random bonding or block bonding.

When the silicone release film includes the alkenyl group-containing organic polysiloxane represented by Formula 4 in the release layer, the silicone release film may have excellent delamination characteristics because one or more crosslink points are generated for every molecular weight less than 4000 of the crosslinked silicone constituting the release layer, and accordingly, dependence of the peel-off strength on the peel-off speed may decrease and an increase of the high-speed peel-off strength relative to the low-speed peel-off strength decreases.

The hydrogen-containing organic polysiloxane may further include an organic polysiloxane represented by Formula 5 below:

{R″₁R″₂R″₃SiO_{1/2}}_{z}{R″₁R″₃SiO_{2/2}}_{y}{R″₂R″₃SiO_{2/2}}ₓ{R″₃SiO_{3/2}}_{w}{SiO_{4/2}}ᵥ Formula 5

In Formula 5,

z may be an integer from 2 to 10,

x and y may be each independently an integer from 1 to 50,

x+y may be an integer from 2 to 80,

w may be 0 and v may be an integer from 0 to 4,

R″₁ may be a substituted or unsubstituted C1-C12 alkyl group,

R″₂ may be hydrogen or a substituted or unsubstituted C1-C12 alkyl group, and

R″₃ may be a methyl group.

The v, w, x, y, and z do not mean block bonding, but they mean sums of repeating units, respectively. In the equation, the repeating units corresponding to the v, w, x, y, and z may be bonded via random bonding or block bonding.

When the silicone release film includes the hydrogen-containing organic polysiloxane represented by Formula 5 in the release layer, the silicone release film may have excellent delamination characteristics because the crosslink points of crosslinked silicone constituting the release layer may be formed more densely, and accordingly, dependence of the peel-off strength on the peel-off speed may decrease and an increase of the high-speed peel-off strength relative to the low-speed peel-off strength decreases.

The silicone release composition may include, for example, an alkenyl group-containing organic polysiloxane represented by Formula 6 below:

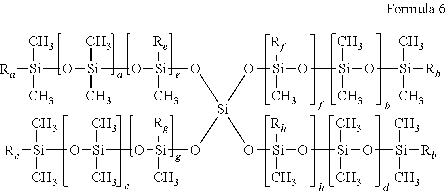

In Formula 6,

a, b, c, and d may be each independently an integer from 1 to 100 and a+b+c+d may be an integer from 10 to 200,

e, f, g, and h may be each independently an integer from 0 to 10 and e+f+g+h may be an integer from 0 to 20,

Rₐ, R_{b}, R_{c}, R_{d}, Rₑ, R_{f}, R_{g}, and Rₕ may be each independently a substituted or unsubstituted C1-C12 alkyl group or a substituted or unsubstituted C2-C12 alkenyl group, and

at least one of Rₐ, R_{b}, R_{c}, R_{d}, Rₑ, R_{f}, R_{g}, and Rₕ may be a substituted or unsubstituted C2-C12 alkenyl group.

The a, b, c, d, e, f, g, and h do not mean block bonding, but they mean sums of repeating units, respectively. In the equation, the repeating units corresponding to the a, b, c, d, e, f, g, and h may be bonded via random bonding or block bonding.

The silicone release composition may include, for example, a hydrogen-containing organic polysiloxane represented by Formula 7 below:

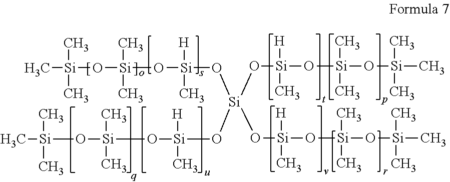

In Formula 7,

o, p, q, and r may be each independently an integer from 1 to 20,

o+p+q+r may be an integer from 4 to 50,

s, t, u, and v may be each independently an integer from 1 to 20, and

s+t+u+v may be an integer from 4 to 50.

The o, p, q, r, s, t, u, and v do not mean block bonding, but they mean sums of repeating units, respectively. In the equation, the repeating units corresponding to the o, p, q, r, s, t, u, and v may be bonded via random bonding or block bonding.

The silicone release composition may satisfy Equation 6 below:

1.5≤S/T≤2.5 Equation 6

In Equation 6,

S is a sum of siloxane repeating units including hydrogen atoms and included in the hydrogen-containing organic polysiloxane, and

T is a sum of alkenyl groups included in the alkenyl group-containing organic polysiloxane.

For example, in the silicone release composition, a ratio of the sum of siloxane repeating units including hydrogen atoms to the sum of the alkenyl groups may be in the range of 1.7 to 2.4, for example, 2.0 to 2.2. When the ratio of the sum of siloxane repeating units including hydrogen atoms and included in the hydrogen-containing organic polysiloxane to the sum of the alkenyl groups included in the alkenyl group-containing organic polysiloxane, both included in the silicone release composition, is within the ranges above, unreacted organic polysiloxane is not remained in the release layer, and thus the silicone release film may have uniform releasing properties and excellent delamination characteristics.

The release layer may satisfy Equation 7 below:

90≤Q≤100 Equation 7

In Equation 7,

Q (%) is a residual adhesion rate of the release layer.

When the measured residual adhesion rate of the release layer is within the above range in the silicone release film, a silicone transfer problem may be prevented, and thus contamination of the adhesive may be inhibited.

The silicone release composition may further include a platinum chelate catalyst, a binder, and a remainder of solvent.

An amount of the platinum chelate catalyst may be in the range of 5 ppm to 500 ppm. When the amount of the platinum chelate catalyst is used within the range above, the platinum chelate catalyst promotes addition reaction between the alkenyl group-containing organic polysiloxane and the hydrogen-containing organic polysiloxane and increases the reaction rate to form crosslinked silicone in the release layer.

The binder may be a silane-based compound having good compatibility with the silicone release composition. The binder may include, for example, at least one type selected from an epoxy silane-based compound, an amino silane-based compound, a vinyl silane-based compound, a methacryloxy silane-based compound, and an isocyanate silane-based compound. The binder may be, for example, a mixture of silane-based compounds including the epoxy silane-based compound as a main component.

The silicone release composition including the binder may induce stable releasing properties by adjusting crosslinking density, improve solvent resistance and durability of the release layer, and improve adhesion between the release layer and the base film.

The remainder of solvent is not particularly limited so long as the solvent may disperse solid components of the silicone release composition and coat the composition on the base film, and may include, for example, water. For example, the silicone release composition may be diluted in an aqueous emulsion dispersed in a solvent including water as a main component and then coated on the base film.

The silicone release composition may have a solid content of 1 wt % to 10 wt %. The silicone release composition may be diluted to the above solid content range and coated on the base film. When the solid content of the silicone release composition is less than 1 wt %, a uniform coating layer cannot be obtained, for example, there may be an uncoated portion, and thus unstable delamination characteristics such as an increase in peel-off strength may be obtained. When the solid content of the silicone release composition exceeds 10 wt %, a coating may have poor appearance, and adhesion between the release layer and the base film may decrease. Thus, durability of the release layer may weaken, and the release layer may be peeled off by an external stimulus such as friction.

The release layer may have a thickness of 0.01 μm to 10 μm. When the thickness of the release layer is within the above range, a uniform release layer may be formed.

The base film may include at least one type selected from a polyimide-based film, a polyolefin-based film, a polyester-based film, a polyacetal-based film, and a polycarbonate-based film. The base film may be, for example, a polyester-based film. The base film may be, for example, a polyester-based film including particles for the convenience of the process.

A protective film for adhesive films according to another embodiment may include the above-described silicone release film.

A protective film for adhesive tapes according to another embodiment may include the above-described silicone release film.

The release film for adhesive films or/and adhesive tapes may be used as a member for optical display devices, but is not limited thereto, and may also be applied all technical fields.

As used herein, the term “substituted” indicates that at least one hydrogen atom of a functional group is substituted with a halogen atom, a C1-C10 alkyl group substituted with a halogen atom (e.g.: CCF₃, CHCF₂, CH₂F, or CCl₃), a C1-C10 alkoxy group, a C2-C10 alkoxyalkyl group, a hydroxyl group, a nitro group, a cyano group, an amino group, an amidino group, a hydrazine group, a hydrazone group, a carboxyl group or a salt thereof, a sulfonyl group, a sulfamoyl group, a sulfonic acid group or a salt thereof, a phosphoric acid group or a salt thereof, a C1-C10 alkyl group, a C2-C10 alkenyl group, a C2-C10 alkynyl group, a C1-C10 heteroalkyl group, a C6-C20 aryl group, a C6-C20 arylalkyl group, a C6-C20 heteroaryl group, a C7-C20 heteroarylalkyl group, a C6-C20 heteroaryloxy group, a C6-C20 heteroaryloxyalkyl group, or a C6-C20 heteroarylalkyl group.

The “halogen” includes F, Br, Cl, and I.

The “alkyl” refers to completely saturated, branched or unbranched (or straight-chain or linear) hydrocarbons. The “alkyl” may be, but is not limited to, methyl, ethyl, n-propyl, isopropyl, n-butyl, isobutyl, sec-butyl, n-pentyl, isopentyl, neopentyl, iso-amyl, n-hexyl, 3-methylhexyl, 2,2-dimethylpentyl, 2,3-dimethylpentyl, or n-heptyl.

The “alkoxy” and “aryloxy” refers to an alkyl or aryl group linked to an oxygen atom, respectively.

The “alkenyl” refers to branched or unbranched hydrocarbons having at least one carbon-carbon double bond. The alkenyl group may be, but is not limited to, vinyl, allyl, butenyl, isoprophenyl, or isobutenyl.

The “alkylnyl” refers to branched or unbranched hydrocarbons having at least one carbon-carbon triple bond. The “alkylnyl” may be, but is not limited to, ethynyl, butynyl, isobutynyl, or isopropynyl.

The “aryl” refers to an aromatic group in which an aromatic ring is fused to at least one carbocyclic ring. The “aryl” may be, but is not limited to, phenyl, naphthyl, or tetrahydronaphthyl.

The “heteroaryl” refers to a monocyclic or bicyclic organic compound including at least one hetero atom selected from N, O, P, and S, with the remaining ring atoms being carbon atoms. For example, the heteroaryl group may include 1 to 5 hetero atoms and 5 to 10 ring members. Here, S or N may be oxidized to form various oxidized states.

The “heteroaryl” may be, but is not limited to, thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl, oxazol-5-yl, isooxazol-3-yl, isooxazol-4-yl, isooxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2-yl, pyrazin-4-yl, pyrazin-5-yl, 2-pyrimidin-2-yl, 4-pyrimidin-2-yl, or 5-pyrimidin-2-yl.

Hereinafter, the configuration of the present disclosure and effects thereof will be described in more detail with reference to the following examples and comparative examples. However, the following examples are merely presented to exemplify the present invention, and the scope of the present disclosure is not limited thereto.

### EXAMPLES

### Example 1: Preparation of Silicone Release Film

An alkenyl group-containing organic polysiloxane represented by Formula 4 (manufactured by Dow Corning Corporation) was mixed with a hydrogen-containing organic polysiloxane represented by Formula 5 (manufactured by Dow Corning Corporation). 1 wt % of an epoxy silane-based compound (manufactured by Dow Corning Corporation, CAS 2530-83-8) and 25 ppm of a platinum chelate catalyst (manufactured by Dow Corning Corporation) were added to the mixture of organic polysiloxanes to obtain a silicone release composition. In this case, the ratio (S/T) of the sum (S) of siloxane repeating units including hydrogen atoms and included in the hydrogen atom-containing organic polysiloxane to the sum (T) of the alkenyl groups included in the alkenyl group-containing organic polysiloxane was adjusted to 2.1.

Then, the silicone release composition was diluted in a remainder of water in the form of an aqueous emulsion to have a solid content of 5 wt % and coated on one side of a corona-treated biaxial stretch polyester base film (Toray Advanced Materials Korea Inc., Excell-50 μm). The coated silicone release composition was dried at 180° C. for 50 seconds to prepare a silicone release film.

{R′₁R′₂R′₃SiO_{1/2}}ₙ{R′₂R′₃SiO_{2/2}}ₘ{R′₃SiO_{3/2}}ₗ{SiO_{4/2}}ₖ Formula 4

In Formula 4,

n is 4, m is 120, l is 0, and k is 1, and

R′₁ is a vinyl group and R′₂ and R′₃ are a methyl group.

{R″₁R″₂R″₃SiO_{1/2}}_{z}{R″₁R″₃SiO_{2/2}}_{y}{R″₂R″₃SiO_{2/2}}ₓ{R″₃SiO_{3/2}}_{w}{SiO_{4/2}}ᵥ Formula 5

In Formula 5,

z is 2, y is 10, x is 20, and w and v are each independently 0, and

R″₁ is a methyl group, R″₂ is hydrogen, and R″₃ is a methyl group.

### Example 2: Preparation of Silicone Release Film

A silicone release film was prepared in the same manner as in Example 1, except that is a hexenyl group instead of the vinyl group in the alkenyl group-containing organic polysiloxane represented by Formula 4 (manufactured by Dow Corning Corporation).

### Example 3: Preparation of Silicone Release Film

A silicone release film was prepared in the same manner as in Example 1, except that the alkenyl group-containing organic polysiloxane represented by Formula 6 was used instead of the alkenyl group-containing organic polysiloxane represented by Formula 4.

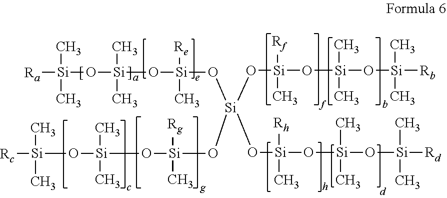

In Formula 6,

a, b, c, and d are each independently 30 and e, f, g, and h are each independently 2, and

Rₐ, R_{b}, R_{c}, R_{d}, Rₑ, R_{f}, R_{g}, and Rₕ are each independently a vinyl group.

### Example 4: Preparation of Silicone Release Film

A silicone release film was prepared in the same manner as in Example 1, except that the ratio (S/T) of the sum (S) of siloxane repeating units including hydrogen atoms and included in the hydrogen atom-containing organic polysiloxane to the sum (T) of the alkenyl groups included in the alkenyl group-containing organic polysiloxane was 1.7 instead of 2.1.

### Example 5: Preparation of Silicone Release Film

A silicone release film was prepared in the same manner as in Example 1, except that the ratio (S/T) of the sum (S) of siloxane repeating units including hydrogen atoms and included in the hydrogen-containing organic polysiloxane to the sum (T) of the alkenyl groups included in the alkenyl group-containing organic polysiloxane was 2.4 instead of 2.1.

### Example 6: Preparation of Silicone Release Film

A silicone release film was prepared in the same manner as in Example 3, except that a and b were each independently 60 instead of 30 and c and d were each independently 30 in the alkenyl group-containing organic polysiloxane represented by Formula 6.

### Example 7: Preparation of Silicone Release Film

A silicone release film was prepared in the same manner as in Example 3, except that a was 90 instead of 30 and b, c, and d were each independently 30 in the alkenyl group-containing organic polysiloxane represented by Formula 6.

### Example 8: Preparation of Silicone Release Film

A silicone release film was prepared in the same manner as in Example 3, except that a, b, c, and d were each independently 10 instead of 30 in the alkenyl group-containing organic polysiloxane represented by Formula 6.

### Example 9: Preparation of Silicone Release Film

A silicone release film was prepared in the same manner as in Example 1, except that a hydrogen-containing organic polysiloxane represented by Formula 7 below was used instead of the hydrogen-containing organic polysiloxane represented by Formula 5 (manufactured by Dow Corning Corporation).

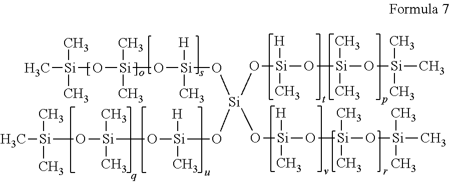

In Formula 7,

o, p, q, and r are each independently 5 and s, t, u, and v are each independently 10.

### Example 10: Preparation of Silicone Release Film

A silicone release film was prepared in the same manner as in Example 1, except that the silicone release composition was coated on one side of a polyimide base film (DuPont, Kapton-50 μm) instead of the corona-treated biaxial stretch polyester base film (Toray Advanced Materials Korea Inc, Excell-50 μm).

Comparative Example 1: Preparation of Silicone Release Film

A silicone release film was prepared in the same manner as in Example 1, except that R′₁ was a methyl group instead of the vinyl group in the alkenyl group-containing organic polysiloxane represented by Formula 4 (manufactured by Dow Corning Corporation).

Comparative Example 2: Preparation of Silicone Release Film

A silicone release film was prepared in the same manner as in Example 3, except that a was 120 instead of 30 and b, c, and d were each independently 60 instead of 30 in the alkenyl group-containing organic polysiloxane represented by Formula 6.

### Comparative Example 3: Preparation of Silicone Release Film

A silicone release film was prepared in the same manner as in Example 1, except that the ratio (S/T) of the sum (S) of siloxane repeating units including hydrogen atoms and included in the hydrogen-containing organic polysiloxane to the sum (T) of the alkenyl groups included in the alkenyl group-containing organic polysiloxane was 1.3 instead of 2.1.

### Comparative Example 4: Preparation of Silicone Release Film

A silicone release film was prepared in the same manner as in Example 1, except that the ratio (S/T) of the sum (S) of siloxane repeating units including hydrogen atoms and included in the hydrogen-containing organic polysiloxane to the sum (T) of the alkenyl groups included in the alkenyl group-containing organic polysiloxane was 2.8 instead of 2.1.

### Comparative Example 5: Preparation of Silicone Release Film

A silicone release film was prepared in the same manner as in Example 1, except that n was 2 instead of 4, m was 100 instead of 120, and k was 0 instead of 1 in the alkenyl group-containing organic polysiloxane represented by Formula 4.

### Evaluation Example 1: Evaluation of Physical Properties of Silicone Release Film

Physical properties of the silicone release films prepared according to Examples 1 to 10 and Comparative Examples 1 to 5 were evaluated according to the following methods. The results are shown in Tables 1 and 2 below, respectively.

### (1) Evaluation of Peel-off Strength

Each of the silicone release films prepared according to Examples 1 to 10 and Comparative Examples 1 to 5 was adhered to a cold-rolled stainless steel plate using a double-sided adhesive tape such that the silicone release layer of the silicone release film faced upward. A standard adhesive tape (TESA 7475) having a width of 1 inch and a length of 30 cm was put on the silicone release layer of the silicone release film and pressed with a 2 kg pressing roller to prepare a sample for peel-off strength measurement.

### (1-1) Measurement of Peel-Off Strength (Room Temperature Storage and Low-speed Peel-Off)

The sample for peel-off strength measurement was stored at room temperature for 1 day and then peel-off strength thereof was measured at a peel-off speed of 0.3 m/min at a peel-off angle of 180° using an AR-1000 tester (manufactured by Chem-Instrument). An average value was obtained by repeating measurement 5 times. In this regard, an obtained low-speed peel-off strength value was referred to as L, R1, or P25.

### (1-2) Measurement of Peel-Off Strength (Room Temperature Storage and High-speed Peel-Off)

The sample for peel-off strength measurement was stored at room temperature for 1 day and then peel-off strength thereof was measured at a peel-off speed of 30 m/min at a peel-off angle of 180° using the AR-1000 tester (manufactured by Chem-Instrument). An average value was obtained by repeating measurement 5 times. In this regard, an obtained high-speed peel-off strength value was referred to as H, and a peel-off strength increase rate relative to the low-speed peel-off strength value L was calculated.

### (1-3) Measurement of Peel-Off Strength (High-Temperature Storage or Long-Term Storage)

The sample for peel-off strength measurement was stored at room temperature for 14 day or stored at 80° C. for 1 day, and then peel-off strength thereof was measured at a peel-off speed of 0.3 m/min at a peel-off angle of 180° using an AR-1000 tester (manufactured by Chem-Instrument). An average value was obtained by repeating measurement 5 times. In this regard, an obtained low-speed peel-off strength value after being stored at room temperature for 14 days was referred to as R14, and an obtained low-speed peel-off strength value after being stored at 80° C. for 1 day was referred to as P80, a peel-off strength increase rate relative to the low-speed peel-off strength value R1 or P25 was calculated.

### (2) Evaluation of Residual Adhesion Rate

A standard adhesive tape (Nitto 31B) having a width of 1 inch and a length of 30 cm was put on the silicone release layer of each of the silicone release films prepared according to Examples 1 to 10 and Comparative Examples 1 to 5, pressed with a 2 kg pressing roller, and maintained at room temperature for 30 minutes. Then, the standard adhesive tape was peeled off from the silicone release layer. The peeled off standard adhesive tape was adhered to a clean cold-rolled stainless steel plate and rolled with a 2 kg pressing roller, and then peel-off strength thereof was measured.

In addition, for comparison, after a standard adhesive tape (Nitto 31B) that has never been used was cut into a width of 1 inch and a length of 30 cm, adhered to a clean cold-rolled stainless steel plate, and pressed with a 2 kg pressing roller, peel-off strength thereof was measured.

Measurement of peel-off strength was performed at a peel-off speed of 0.3 m/min at a peel-off angle of 180° using an AR-1000 tester (manufactured by Chem-Instrument). An average value was obtained by repeating measurement 5 times.

The residual adhesion rate was calculated according to Equation 8 below.

Residual adhesion rate (%)=[(peel-off strength of standard adhesive tape peeled off from release layer)/(peel-off strength of standard adhesive tape not used)]×100 Equation 8

### (3) Evaluation of Surface Change in Rubbing Test (Visual Observation)

After rubbing the release layer by reciprocating 10 times with a thumb while applying a force, change of the surface was observed by visual observation. As a result, surface change was evaluated as follows:

⊚: No change after evaluation

O: Slightly change but no problem in use

Δ: Hazy surface of release layer

X: Delamination of release layer

TABLE 1

| | Exam- | Exam- | Exam- | Exam- | Exam- | Exam- | Exam- | Exam- | Exam- | Exam- |
|---|---|---|---|---|---|---|---|---|---|---|
| | ple 1 | ple 2 | ple 3 | ple 4 | ple 5 | ple 6 | ple 7 | ple 8 | ple 9 | ple 10 |
| L (R1, P25 | 18 | 19 | 20 | 13 | 23 | 16 | 15 | 24 | 18 | 21 |
| R1 = P25) | | | | | | | | | | |
| H | 29 | 31 | 27 | 25 | 33 | 31 | 29 | 27 | 23 | 36 |
| H/L | 1.61 | 1.63 | 1.35 | 1.92 | 1.43 | 1.94 | 1.93 | 1.13 | 1.28 | 1.71 |
| R14 | 20 | 18 | 24 | 14 | 30 | 18 | 18 | 29 | 21 | 26 |
| R14/R1 | 1.11 | 1.06 | 1.20 | 1.08 | 1.30 | 1.13 | 1.20 | 1.21 | 1.17 | 1.24 |
| P80 | 22 | 19 | 27 | 14 | 34 | 20 | 20 | 34 | 23 | 28 |
| P80/P25 | 1.22 | 1.12 | 1.35 | 1.08 | 1.48 | 1.25 | 1.33 | 1.42 | 1.28 | 1.33 |
| Residual | 94 | 97 | 96 | 91 | 99 | 93 | 91 | 91 | 99 | 97 |
| adhesion | | | | | | | | | | |
| rate | | | | | | | | | | |
| Surface | ⊚ | ⊚ | ⊚ | ◯ | ⊚ | ⊚ | ◯ | ◯ | ⊚ | ⊚ |
| Change by | | | | | | | | | | |
| Rubbing | | | | | | | | | | |
| (Visual | | | | | | | | | | |
| Observation) | | | | | | | | | | |

TABLE 2

| | Compar- | Compar- | Compar- | Compar- | Compar- |
|---|---|---|---|---|---|
| | ative | ative | ative | ative | ative |
| | Exam- | Exam- | Exam- | Exam- | Exam- |
| | ple 1 | ple 2 | ple 3 | ple 4 | ple 5 |
| L | 7 | 15 | 9 | 30 | 17 |
| (R1, P25 | | | | | |
| R1 = P25) | | | | | |
| H | 9 | 33 | 20 | 44 | 44 |
| H/L | 1.28 | 2.20 | 2.22 | 1.47 | 2.59 |
| R14 | 9 | 20 | 11 | 52 | 19 |
| R14/R1 | 1.28 | 1.33 | 1.22 | 1.73 | 1.12 |
| P80 | 11 | 25 | 10 | 73 | 20 |
| P80/P25 | 1.57 | 1.67 | 1.11 | 2.43 | 1.18 |
| Residual | 41 | 88 | 73 | 99 | 91 |
| adhesion rate | | | | | |
| Surface | X | ◯ | Δ | ⊚ | Δ |
| Change by | | | | | |
| Rubbing | | | | | |
| (Visual | | | | | |
| Observation) | | | | | |

Referring to Table 1, the silicone release films prepared in Examples 1 to 10 had a low-speed peel-off strength value of 10 gram/inch to 25 gram/inch when peeled off at a peel-off speed of 0.3 m/min. Thus, when the silicone release films are used as protective films of adhesive layers, it may be confirmed that the silicone release films are lightly peeled off while maintaining an adhered state to the adhesive layer.

Also, the silicone release films prepared in Examples 1 to 10 had a high-speed peel-off strength value of 10 gram/inch to 40 gram/inch when peeled off at a peel-off speed of 30 m/min. Because the increase in peel-off strength at the high-speed peel-off is suppressed twice or less relative to the low-speed peel-off, it may also be confirmed that the silicone release films are lightly peeled off at a high-speed peel-off. Therefore, when the silicone release films are used as protective films of adhesive layers, problems of tearing of the adhesive layer or delamination of the adhesive layer together therewith may be prevented.

This is because, in the silicone release films prepared according to Examples 1 to 10, weight average molecular weights (Mw) of silicone polymer chains present between crosslink points of the crosslinked release layers were adjusted less than 4000, and the siloxane repeating units including the alkenyl groups and hydrogen atoms for forming the crosslinked silicone have optimum amounts. Because siloxane repeating units including the alkenyl groups and the hydrogen atoms are distributed in molecules in appropriate densities, unreacted functional groups are not remained in the release layer. Thus, it is considered that changes in physical properties are inhibited because the degree of increase in peel-off strength is small while the adhered state is maintained for a long time even by external environmental changes such as exposure to high temperature, passage of time, or temperature change.

Also, because the residual adhesion rates of the silicone release films prepared in Examples 1 to 10 are remained 90% or more, problems caused by silicone transfer may be prevented. Therefore, the silicone release films may be used as protective films of adhesive layers because contamination of the adhesive layers may be prevented and excellent durability may be obtained, for example, the release layer is not delaminated by fraction or the like.

In comparison, because siloxanes are not crosslinked in the silicone release film prepared according to Comparative Example 1, the adhered state to the adhesive layer cannot be maintained due to too low peel-off strength value when peeled off at a peel-off speed of 0.3 m/m in and the adhesive layer may be contaminated by silicone transfer due to too low residual adhesion rate. Thus, the silicone release film prepared according to Comparative Example 1 is not suitable as a release film.

The weight average molecular weight (Mw) of silicon polymer chains present between crosslink points of the crosslinked release layers were 4000 or more as the molecular weight of the alkenyl group-containing organic polysiloxane in the silicone release film prepared according to Comparative Example 2. Thus, it may be confirmed that the peel-off strength relative to peel-off speed increases due to low effects on inhibiting the increase in peel-off strength at high-speed peel-off compared to low-speed peel-off. Accordingly, delamination characteristics deteriorate at the high-speed peel-off. Problems of tearing of the adhesive layer or delamination of the adhesive layer together therewith may occur when the silicone release film is used as a protective film of the adhesive layer. Therefore, the silicone release film prepared according to Comparative Example 2 is not suitable as a release film.

In the silicone release film prepared according to Comparative Example 3 or 4, the ratio of the sum of siloxane repeating units including hydrogen atoms and included in the hydrogen-containing organic polysiloxane to the sum of the alkenyl groups included in the alkenyl group-containing organic polysiloxane is in the range of 1.3 or 2.8 which is out of the appropriate range of 1.5 to 2.5.

In the silicone release composition, when the ratio (S/T) of the sum of siloxane repeating units including hydrogen atoms and included in the hydrogen-containing organic polysiloxane to the sum of the alkenyl groups included in the alkenyl group-containing organic polysiloxane is insufficient as 1.3, unreacted alkenyl group-containing organic polysiloxane remains in the release layer, resulting in a decrease in the residual adhesion rate. Therefore, the silicone release film is not suitable as a release film.

In the silicone release composition, when the ratio (S/T) of the sum of siloxane repeating units including hydrogen atoms and included in the hydrogen-containing organic polysiloxane to the sum of the alkenyl groups included in the alkenyl group-containing organic polysiloxane is excessive as 2.8, peel-off strength excessively increases by passage of time or temperature changes due to unreacted hydrogen-containing organic polysiloxane, resulting in deterioration of delamination characteristics. Therefore, the silicone release film is not suitable as a release film.

In the silicone release film prepared according to Comparative Example 5, the peel-off strength considerably increases relative to peel-off speed. Therefore, delamination characteristics may deteriorate at a high-speed peel-off, and thus the adhesive layer may be torn, or the adhesive layer may be peeled off together with the silicone release film when the silicone release film is used as a protective film. Therefore, the silicon release film is not suitable as a release film.

While one or more embodiments have been described with reference to the figures, it will be understood by those of ordinary skill in the art that various changes in form and details may be made therein without departing from the spirit and scope of the disclosure as defined by the following claims.

1. A silicone release film comprising:
a base film; and
a release layer located on at least one side of the base film and comprising a silicone release composition,
wherein the release layer satisfies all of Equations 1 to 3 below:
10≤L≤25 Equation 1
10≤H≤40 Equation 2
1≤H/L≤2 Equation 3
in Equations 1 to 3,
L (gram/inch) is a low-speed peel-off strength value measured at a peel-off speed of 0.3 m/min,
H (gram/inch) is a high-speed peel-off strength value measured at a peel-off speed of 30 m/min, and
the low-speed peel-off strength value and the high-speed peel-off strength value are values measured after a TESA7475 tape was pressed in a reciprocating manner and maintained at room temperature for 1 day, respectively.

2. The silicone release film of claim 1, wherein the release layer satisfies both Equations 4 and 5 below:
1.0≤R14/R1≤1.5 Equation 4
1.0≤P89/P25≤1.5 Equation 5
in Equations 4 and 5,
R1 (gram/inch) is a low-speed peel-off strength value measured at a peel-off speed of 0.3 m/min after a TESA7475 tape was pressed in a reciprocating manner and maintained at room temperature for 1 day,
R14 (gram/inch) is a low-speed peel-off strength value measured at a peel-off speed of 0.3 m/min after a TESA7475 tape was pressed in a reciprocating manner and maintained at room temperature for 14 days,
P25 (gram/inch) is a low-speed peel-off strength value measured at a peel-off speed of 0.3 m/min after a TESA7475 tape was pressed in a reciprocating manner and maintained at room temperature for 1 day, and
P80 (gram/inch) is a low-speed peel-off strength value measured at a peel-off speed of 0.3 m/min after a TESA7475 tape is pressed in a reciprocating manner and maintained at 80° C. for 1 day.

3. The silicone release film of claim 1, wherein the silicone release composition comprises an alkenyl group-containing organic polysiloxane including a substituted or unsubstituted C2-C12 alkenyl group, a hydrogen-containing organic polysiloxane, or any combination thereof.

4. The silicone release film of claim 3, wherein the silicone release composition comprises structural units represented by Formulae 1 to 3 below: 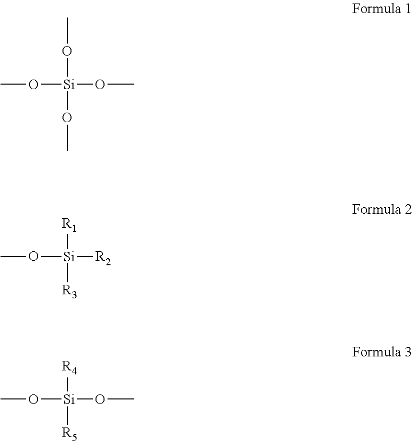
in Formulae 1 to 3, R₁, R₂, R₃, R₄, and R₅ may be each independently a substituted or unsubstituted C1-C12 alkyl group or a substituted or unsubstituted C2-C12 alkenyl group.

5. The silicone release film of claim 4, wherein the silicone release composition comprises at least one structural unit represented by Formula 1 and at least four structural units represented by Formula 2.

6. The silicone release film of claim 3, wherein the alkenyl group-containing organic polysiloxane comprises an organic polysiloxane represented by Formula 4 below:
{R′₁R′₂R′₃SiO_{1/2}}ₙ{R′₂R′₃SiO_{2/2}}ₘ{R′₃SiO_{3/2}}ₗ{SiO_{4/2}}ₖ Formula 4
wherein in Formula 4,
n may be an integer from 4 to 10,
m may be an integer from 10 to 200,
l may be 0,
k may be an integer from 1 to 4,
R′₁ and R′₂ may be each independently a substituted or unsubstituted C1-C12 alkyl group or a substituted or unsubstituted C2-C12 alkenyl group,
R′₃may be a substituted or unsubstituted methyl group, and at least one of R′₁ and R′₂ may be a substituted or unsubstituted C2-C12 alkenyl group.

7. The silicone release film of claim 3, wherein the hydrogen-containing organic polysiloxane further comprises an organic polysiloxane represented by Formula 5 below:
{R″₁R″₂R″₃SiO_{1/2}}_{z}{R″₁R″₃SiO_{2/2}}_{y}{R″₂R″₃SiO_{2/2}}ₓ{R″₃SiO_{3/2}}_{w}{SiO_{4/2}}ᵥ Formula 5
wherein in Formula 5,
z may be an integer from 2 to 10,
x and y may be each independently an integer from 1 to 50,
x+y may be an integer from 2 to 80,
w may be 0 and v may be an integer from 0 to 4,
R″₁ may be a substituted or unsubstituted C1-C12 alkyl group,
R″₂ may be hydrogen or a substituted or unsubstituted C1-C12 alkyl group, and
R″₃ may be a methyl group

8. The silicone release film of claim 1, wherein the silicone release composition comprises an alkenyl group-containing organic polysiloxane represented by Formula 6 below: 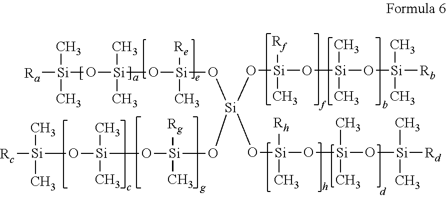
wherein in Formula 6,
a, b, c, and d are each independently an integer from 1 to 100 and a+b+c+d is an integer from 10 to 200,
e, f, g, and h are each independently an integer from 0 to 10 and e+f+g+h is an integer from 0 to 20,
Rₐ, R_{b}, R_{c}, R_{d}, Rₑ, R_{f}, R_{g}, and Rₕ may be each independently a substituted or unsubstituted C1-C12 alkyl group or a substituted or unsubstituted C2-C12 alkenyl group, and
at least one of Rₐ, R_{b}, R_{c}, R_{d}, Rₑ, R_{f}, R_{g}, and Rₕ may be a substituted or unsubstituted C2-C12 alkenyl group.

9. The silicone release film of claim 1, wherein the silicone release composition comprises a hydrogen-containing organic polysiloxane represented by Formula 7 below: 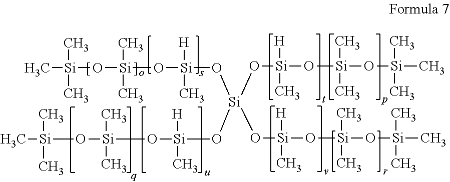
wherein in Formula 7,
o, p, q, and r are each independently an integer from 1 to 20,
o+p+q+r is an integer from 4 to 50,
s, t, u, and v are each independently an integer from 1 to 20, and
s+t+u+v is an integer from 4 to 50.

10. The silicone release film of claim 1, wherein the silicone release composition satisfies Equation 6 below:
1.5≤S/T≤2.5 Equation 6
wherein in Equation 6,
S is a sum of siloxane repeating units comprising hydrogen atoms and included in the hydrogen-containing organic polysiloxane, and
T is a sum of alkenyl groups included in the alkenyl group-containing organic polysiloxane.

11. The silicone release film of claim 1, wherein the release layer satisfies Equation 7 below:
90≤Q≤100 Equation 7
wherein in Equation 7,
Q (%) is a residual adhesion rate of the release layer.

12. The silicone release film of claim 1, wherein the silicone release composition further comprises a platinum chelate catalyst, a binder, and a remainder of solvent.

13. The silicone release film of claim 12, wherein an amount of the platinum chelate catalyst is from 5 ppm to 500 ppm.

14. The silicone release film of claim 12, wherein the binder comprises at least one selected from an epoxy silane-based compound, an amino silane-based compound, a vinyl silane-based compound, a methacryloxy silane-based compound, and an isocyanate silane-based compound.

15. The silicone release film of claim 12, wherein the remainder of solvent comprises water.

16. The silicone release film of claim 1, wherein the silicone release composition has a solid content of 1 wt % to 10 wt %.

17. The silicone release film of claim 1, wherein the release layer has a thickness of 0.01 μm to 10 μm.

18. The silicone release film of claim 1, wherein the base film comprises at least one type selected from a polyimide-based film, a polyolefin-based film, a polyester-based film, a polyacetal-based film, and a polycarbonate-based film.

19. A protective film for an adhesive film, comprising the silicone release film according to claim 1.

20. A protective film for an adhesive tape, comprising the silicone release film according to claim 1.
